(19) United States
(12) Patent Application Publication
(10) Pub. No.: US 2005/0174676 A1
(43) Pub. Date: Aug. 11, 2005

(54) Method and device for data protection

(75) Inventor: Chi-Kuei Lin, Taipei (TW)

Correspondence Address: BRUCE H. TROXELL, SUITE 1404, 5205 LEESBURG PIKE, FALLS CHURCH, VA, 22041, US

(73) Assignee: Signal Electronic Co., Ltd.

(21) Appl. No.: 10/958,360

(22) Filed: Oct. 6, 2004

(30) Foreign Application Priority Data
Feb. 10, 2004 (TW) 93102989

(51) Int. Cl. G11B 23/02

(52) U.S. Cl. 360/60

(57) ABSTRACT

The invention relates to a method and device of data protection. The method of data protection comprises the steps of: detecting movement of a storage media; and disabling the storage media when the storage media moves beyond an acceptable limit. Thereby, when the storage media moves improperly, the storage media is disabled to prevent the stored data from losing or erroneous reading/writing. If the device corresponding to the method described above is connected to a computer via a universal serial bus interface, a better protection is provided for the hard disc drive of the computer.

### FIELD OF THE INVENTION

The present invention relates to a method of data protection, and in particular to a method and device using a sensor for data protection.

### BACKGROUND OF THE INVENTION

A hard disc drive is a main device for data storage in personal computer. A hard disc drive referred as Winchester hard disc drive is a metal case having one or more metal discs accommodated therein, and can write or read data by magnetizing surface material of the metal discs. A hard disc has a larger storage capacity than a floppy disc, and rotational speed thereof ranges from 3600 to 10000 rpm according to various brands and types. The gap between the head and the disc is 8 to 12 micro meters, which is smaller than a dust. Therefore, the hard disc is very sensitive, even the slightest amount of dust can cause damage so that an airtight seal is essential. The storage capacity of a hard disc drive is enlarged from tens of megabyte to tens of gigabyte.

Since the hard disc drive is a high precision instrument with internal discs rotating in high speed, impact should be avoided during operating a hard disk drive in order to prevent erroneous accessing or even damage. Even when the hard disc drive is at rest.

However, up till now, except for the protection for power failure and the protection for insufficient power, the protections of hard disc drive are limited to the shockproof measures for preventing impacts of falling, shaking or collision. When the hard disc drive is impacted or crashed to ground that causes an erroneous parking of the reading head, the data stored in a hard disc drive are easily lost or can be erroneously read/written.

In view of the above description, a method and device for data protection is needed such that the data stored in a storage media is protected when the storage media is improperly moved.

### SUMMARY OF THE INVENTION

Accordingly, an object of the invention is to provide a method of data protection, which comprises the steps of: detecting movement of a storage media; and disabling the storage media when the storage media moves beyond an acceptable limit.

In a preferred embodiment of the invention, the movement of the storage media is detected according to the acceleration generated by the movement of the storage media, such as moving upward, downward, toward left and toward right.

Take the hard disc drive used in a personal computer for example, a sensor can be built in the hard disc drive for detecting the movement thereof. In addition, the sensor can be coupled to an internal control unit of the personal computer, such that the sensor can signal the control unit to disable the hard disc drive or park the reading head when the movement of the hard disc drive is beyond an acceptable limit.

The sensor can also be an external device that is externally connected to the personal computer for detecting the movement of the hard disc drive. In this regard, the sensor can connects to the computer via a universal serial bus interface. Thereby, the sensor can signal the operation system of the computer to alarm the control unit for disabling the hard disc drive when the hard disc drive moves beyond the acceptable limit.

Another object of the invention is to provide a device for data protection, which comprises a sensor and a control unit. The sensor is used for detecting the movement of a storage media and sending a sensing signal. The control unit receives the sensing signal and controls the operations of the storage media accordingly.

To sum up, the invention provides a method and a device for data protection, which is capable of protecting the data stored in storage media when the storage media is improperly moved.

### BRIEF DESCRIPTION OF THE DRAWINGS

The present invention can be more fully understood by reading the subsequent detailed description and examples with references made to the accompanying drawings, wherein:

FIG. 1 is flowchart illustrating a method of data protection according to a preferred embodiment of the invention; and

FIG. 2 is a schematic view showing a preferred embodiment of a device for data protection according to the invention.

### DESCRIPTION OF THE PREFERRED EMBODIMENT

For further understanding the objects, the characteristics, and the functions of the present invention, a detailed description matched with corresponding drawings are presented as follows.

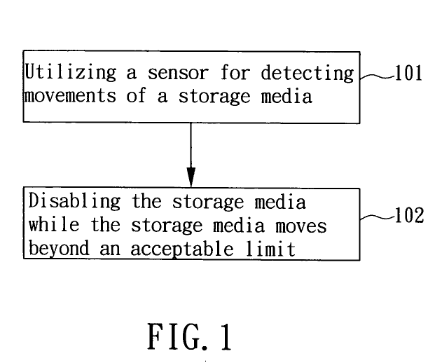

Please refer to FIG. 1, which is flowchart illustrating a method of data protection according to a preferred embodiment of the invention. As seen in step 101, a sensor is utilized to detect movements of a storage media such as a hard disc drive, for example the sensor is alarmed by detecting an acceleration generated by a movement of the hard disc drive. Thus, no matter the sensor is built in the hard disc drive or externally connected to a computer in which the storage media is disposed via a universal serial bus interface, the movement of the storage media can be detected by the sensor as a force is exerted on the computer with the storage media and cause a relative movement between the storage media and the computer.

In step 102, when the storage media moves beyond an acceptable limit, for example, move too fast or shake too heavy in all directions, the sensor can alarm the computer to disable the storage media for protecting the stored data.

As for a sensor connected to a personal computer externally via a universal serial bus interface, when the sensor detects the storage media moving beyond the acceptable limit, the sensor will issue an alarm signal to the computer in which the storage media is disposed via the universal serial bus interface. In this preferred embodiment, the sensor issues an alarm signal to a control unit in the computer such as a chip set or a single chip. Therefore, when the control unit receives the alarm signal from the sensor, the firmware of the control unit or an operation system will disable the storage media via the control unit.

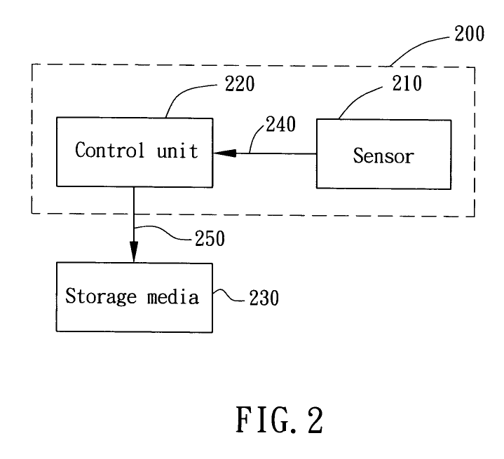

Referring to FIG. 2, the device for data protection 200 comprises a sensor 210 and a control unit 220. The sensor 210 is connected to a computer (not shown) in which a storage media 230 is disposed via a universal serial bus interface.

When the computer is forced to move, the sensor 210 connected to the computer is also moved with respect to the computer. Thus, the sensor 210 detects the movement of the storage media 230 and sends a signal 240 to the control unit 220 of the computer. The signal 240 varies according to the movement of the storage media 230 detected by the sensor 210.

A firmware of the control unit 220 or an operation system thereof can determine whether the storage media moves beyond the limit. If the control unit 220 determines that the storage media had moved beyond the limit, a control signal 250 is sent from the control unit 220 to disable the storage media 230. Moreover, if the storage media 250 is a hard disc drive, then the reading head of the hard disc drive is parked.

If a storage media is provided with the device disclosed in the invention, then the movement thereof can be detected immediately, and appropriate protection is provided while detecting a beyond-limit movement (e.g. protecting the reading head from damaging). Thereby, this prevents the stored data from losing.

In addition, the data protection device of the invention can also be applied to a portable disk drive in which a sensor and a control unit are built. When the portable disk drive is connected to a computer via a universal serial bus interface, the portable disk drive serves as a storage media and can detect whether the movement of a hard disc drive of the computer is beyond a limit, and the control unit provides protection for the hard disc drive.

The invention provides a method and device for data protection. By means of detecting movement of the storage media, the control unit can protect the stored data when the storage media is improperly moved so that the storage media is not damaged and the stored data are not lost.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method of data protection, comprising the steps of:
detecting a movement of a storage media; and
disabling the storage media when the storage media moves beyond an acceptable limit.

2. The method as claimed in claim 1 further comprising: detecting the movement of the storage media according to the acceleration generated by the movement.

3. The method as claimed in claim 2 further comprising: detecting the movement of the storage media according to acceleration thereof in moving upward, downward, toward left and toward right.

4. The method as claimed in claim 3, wherein the storage media is a hard disc drive of a computer.

5. The method as claimed in claim 4 further comprising: building a sensor in the hard disc drive to detect the movement thereof.

6. The method as claimed in claim 5 further comprising: providing a control unit in the computer coupled to the sensor for receiving an alarm signal from the sensor and disabling the storage media as the hard disc drive moves beyond the acceptable limit.

7. The method as claimed in claim 6, wherein the control unit is a chip set.

8. The method as claimed in claim 6, wherein the control unit is a single chip.

9. The method as claimed in claim 8 further comprising: parking the reading head of the hard disc drive by the single chip as the hard disc drive moves beyond the acceptable limit.

10. The method as claimed in claim 4 further comprising: externally connecting a sensor to the computer to detect the movement of the hard disc drive.

11. The method as claimed in claim 10 further comprising: externally connecting the sensor to the computer via a universal serial bus interface to detect the movement of the hard disc drive.

12. The method as claimed in claim 11 further comprising: connecting the sensor to an operation system of the computer via the universal serial bus interface, wherein the sensor informs the operation system to disable the storage media as the hard disc drive moves beyond the acceptable limit.

13. A device for data protection, comprising:
a sensor, being used for detecting a movement of a storage media and issuing a signal; and
a control unit, being used for receiving the signal to control the operation of the storage media.

14. The device as claimed in claim 13, wherein the storage media is a hard disc drive of a computer.

15. The device as claimed in claim 14, wherein the sensor is built in the hard disc drive.

16. The device as claimed in claim 14, wherein the sensor is externally connected to the computer.

17. The device as claimed in claim 16, wherein the sensor is externally connected to the computer via a universal serial bus interface.

18. The device as claimed in claim 13, wherein the control unit is a chip set.

19. A portable disc drive with data protection capability, comprising:
a sensor, being used for detecting a movement of a storage media and issuing a signal; and
a control unit, being used for receiving the signal to control the operationt of the storage media.

20. The portable disc drive as claimed in claim 19, wherein the storage media is a hard disc drive of a computer.

21. The portable disc drive as claimed in claim 20, wherein the portable disc drive is externally connected to the computer via a universal serial bus interface.
